(19) United States
(12) Patent Application Publication
(10) Pub. No.: US 2019/0332093 A1
(43) Pub. Date: Oct. 31, 2019

(54) System And Method For Managing Waste And For Documenting Waste Management

(71) Applicant: Industrial Waste Processors, LLC, Castle Rock, CO (US)

(72) Inventors: Paul Isham, Castle Rock, CO (US); Benjamin Meyer, Loveland, CO (US); Marshall Spring, Loveland, CO (US); Corbett Hefner, Monte Vista, CO (US); William Finch, Greenwood Village, CO (US)

(73) Assignee: Industrial Waste Processors, LLC

(21) Appl. No.: 16/393,664

(22) Filed: Apr. 24, 2019

Related U.S. Application Data
(60) Provisional application No. 62/662,279, filed on Apr. 25, 2018.

(51) Int. Cl. G05B 19/416

(52) U.S. Cl. CPC G05B 19/416; H04L 63/0428

(57) ABSTRACT

A machine is configured to grind and/or shred a waste material and to mix the waste material with a filler material so as to dilute the waste material to a desired level, such as on a minority basis by weight. The machine also includes a blender that grinds or shreds the waste material and the filler material received from drum while mixing the materials together. Materials may be supplied to the blender by a drum located above the blender and/or a hopper located remote from the blender and coupled to the blender by a conveyor. The waste material may be rendered unusable and unrecognizable in the resultant mixture. A computer system can store the various measurements in an internal memory and/or transmit the various measurement to a remote server. Information that supports a finding of compliance with a given regulation can be transmitted to relevant parties.

### CROSS-REFERENCE TO RELATED APPLICATION

The present application claims priority on U.S. Provisional Patent Application Ser. No. 62/662,279, filed Apr. 25, 2018 and entitled System and Method for Managing Waste and Documenting Waste Management, the entirety of which is hereby incorporated herein by reference.

### BACKGROUND OF THE INVENTION

### 1. Field of the Invention

The present invention relates generally to managing waste and, more particularly, to a system that manages waste material by diluting and blending them with fillers material. The invention additionally relates to a method of operating such a system, as well to a system and method of documenting and reporting operation of such a system and the processing of waste materials.

### 2. Discussion of the Related Art

Certain waste materials cannot be simply thrown away into the garbage or other waste receptacle, flushed down a toilet, or otherwise be disposed of for fear that a third party might contact or collect the waste material. For instance, the United States Food and Drug Administration (FDA) has stringent regulations related to the disposal of prescription drugs. In the event that prescription drugs are no longer needed, the FDA has regulations aimed to help reduce the risk of harm from accidental exposure or intentional misuse of these drugs by others. The FDA provides a number of different alternatives to dispose of such drugs, including use of the Drug Enforcement Administration (DEA), use of collectors registered with the DEA, mixing medicines with unpalatable substances like dirt, cat litter, or used coffee grounds, or in limited situations flushing such medications down the toilet.

Similar concerns exist for other waste materials that for whatever reason cannot simply be disposed of or used in an undiluted form. Such materials include various chemical compositions, materials that cause skin irritation, substances that can cause sickness or poisoning, and other substances, such as cannabis waste including trim, stalks, stems, roots, and the like.

Disposal or other management of such waste materials often also requires compliance with preset standards. For example, the State of Colorado has strict regulations for the disposal of cannabis waste. These regulations require that the cannabis waste be blended on a minority basis with a filler material while being rendered unusable and unrecognizable. Failure to comply with such regulations can result in very stiff penalties. In the case of failure to comply with government regulations, these penalties may include monetary fines, business closings, and even jail time.

It therefore is desirable to dilute such materials with filler or inert material, such as coir fiber, straw, cardboard, paper, Bokashi, soil, or other materials, to reduce risks of improper use of the waste products. For instance, in light of some regulations, it is desirable to dilute such waste materials by at least 51% by weight of the blended final waste product.

It is also desirable to blend waste material with filler material while rendering the waste material unusable and unrecognizable.

It is also desirable to document waste management, also known as waste processing, in compliance with preset regulations and to report that compliance. The term “regulation” as used herein should be understood to mean a preset requirement, standard or criterion. It may be preset by a government agency or a private enterprise such as an industry standard.

What is needed is an improved system that is capable of diluting and blending various waste products with a filler or inert material.

What is further needed is an improved waste management system that automatically documents compliance with predetermined management regulations on a real time basis and that documents such compliance.

What is further needed is a method of ensuring compliance with relevant regulations and properly documenting such compliance.

### SUMMARY OF THE INVENTION

In accordance with an aspect of the invention, a system is provided that assists in the management of waste materials, also referred to as the processing of waste materials, and ways in which compliance with applicable standards such as government regulations can be demonstrated. The system may include a machine having a blender and a computerized system that monitors blending of the waste material with filler material in compliance with designated standards, and a computerized system that monitors and reports such compliance on a real-time basis.

The blender may comprise a grinder that grinds, shreds or chops designated respective masses of incoming waste and filler materials and mixes the materials while chopping them. Materials may be fed to the blender by a rotating drum located over the blender.

Measures may be incorporated into the system to monitor the proportions of waste and filler materials being ground and blended. For example, a scale, possibly taking the form of load cells, may be mounted about the machine so as to be capable of taking various measurement readings of contents of machine and of transmitting their measurements to the system's computer. These readings may be stored in the computer's memory and/or transmitted directly or indirectly to a third-party computer to ensure compliance with a designated regulation. One or more of these scales may be located under the blender, under a receptacle that receives materials from the blender, and/or under a hopper that feeds materials to the blender via an intervening conveyor.

The machine may also include a plurality of lids or doors that are lockable relative to the machine to limit access to an interior of the machine, especially when the grinder is turned on. For instance, a top lid may be provided that can lockably cover a top opening in the drum. A sliding door may also be locked into place to restrict access to the storage bin. Additionally, the machine may have a frame and panels affixed to the frame, with the interior located within the frame and panels. The combination of the lockable lids or doors and the frame and panels limits access to the interior for safety purposes and to ensure compliance with relevant regulations relating to the dilution of the waste material

In accordance with another aspect of the invention, the system may include a blender and a separate hopper that is configured to receive a quantity of waste material and a quantity of filler material, as well as at least one conveyor that extends from the hopper system to the blender. The hopper and the machine may be mounted to a portable trailer or otherwise be transportable as a unit.

In accordance with another aspect of the invention, a method of demonstrating compliance relating to dilution of a waste material comprises adding waste material and a filler material to a receptacle to form a combined mass, and mixing and grinding combined mass in a blender to form a mixture. The method additionally includes weighing the combined mass (either before or after it is mixed and ground to form a mixture), generating a weight signal indicative thereof, and transmitting the signal to a computer. The method still additionally includes, using the computer, and relying at least in part on the signal, determining whether a quantity of waste material in the combined mass is diluted to a designated level, and at least one of storing and transmitting information regarding dilution of the waste material relative to the combined mass.

In one possible implementation, the weight of the combined mass is measured prior to formation of the mixture, and the weight of the mixture can then be measured after the mixture is formed and the mixture is discharged into a receptacle. If the measured mixture weight is substantially the same as the measured weight of the combined mass, a transmission report may be generated. If the measured mixture weight is not substantially the same as the measured weight of the combined mass, an error signal may be generated, and an audible and/or visual alert may be generated.

The weight of the components of the combined mass may be measured sequentially, with the weight of either the filler or the waste material first being measured, and with the system prompting the operator to continue to add one or the other of the components until the desired dilution level is achieved.

Any measurement documentation can be transmitted to a third party such as governmental compliance agency either directly or through the cloud or some other database accessible by the third party. Transmission of and access to the data may be on an encrypted and/or other secure basis.

The method may also include the restricting of access within the machine, for instance by locking and unlocking a top lid or other doors depending on whether or not the grinder is activated or deactivated.

The method may also include adding the waste material and the second filler material initially to a hopper to form the combined mass, after which the combined mass is transported to the machine for mixing and grinding.

Other objects, features and advantages of the present invention will become apparent after review of the specification, claims and drawings. The detailed description and examples enhance the understanding of the invention but are not intended to limit the scope of the appended claims.

### BRIEF DESCRIPTION OF THE DRAWINGS

Preferred exemplary embodiments of the invention is illustrated in the accompanying drawings in which like reference numerals represent like parts throughout, and in which:

FIG. 1 is a functional diagram showing a system for managing waste and demonstrating compliance with applicable regulations and steps associated with operation of the system;

FIG. 2 is a top perspective view of one embodiment of a waste and filler blending machine used with the system for managing waste and demonstrating compliance with applicable regulations;

FIG. 3 is a front elevation view of the machine of FIG. 2 showing some panels removed to expose the interior components of the machine;

FIG. 4 is a rear elevation view of the machine of FIGS. 2 and 3, showing some panels removed to expose the interior components of the machine;

FIG. 5 is a side elevation view of a first side of the machine of FIGS. 2-4, showing some panels removed to expose the interior components of the machine;

FIG. 6 is a side elevation view of a second side of the machine of FIGS. 2-5, showing some panels removed to expose the interior components of the machine;

FIG. 7 is a top plan view of the machine of FIGS. 2-6, where a top lid has been removed to show the interior of a drum associated with the machine;

FIG. 8 is a bottom plan view of the machine of FIGS. 1-7 where a bottom panel has been removed to show the interior components of the machine;

FIG. 9 is a cutaway front elevation view of the machine of FIGS. 2-8 taken about line 9-9 of FIG. 7, showing the interior components of the machine;

FIG. 10 is a top perspective view of a shredder and motor contained within the machine;

FIG. 11 is a front side elevation of the shredder shown in FIG. 10;

FIG. 12 is a flow chart showing a method of using the system of FIG. 1;

FIG. 13 is a top perspective view of another embodiment of a waste and filler blending machine that is portable and is used with a system for managing waste and demonstrating compliance with applicable regulations;

FIG. 14 is a front elevation view of the machine of FIG. 13, showing some panels removed to expose the interior components of the machine;

FIG. 15 is a top plan view of the machine of FIGS. 13-14; and

FIG. 16 is a side elevation view of a second side of the machine of FIGS. 13-15; and

FIG. 17 is a flow chart showing a method of using the system of FIGS. 13-16.

### DETAILED DESCRIPTION OF THE PREFERRED EMBODIMENT

A wide variety of different systems capable of managing waste and demonstrating compliance with applicable regulations could be constructed in accordance with the invention as defined by the claims. Hence, while exemplary embodiments of the invention will now be described, it should be understood that the invention is in no way limited to any of the described embodiments.

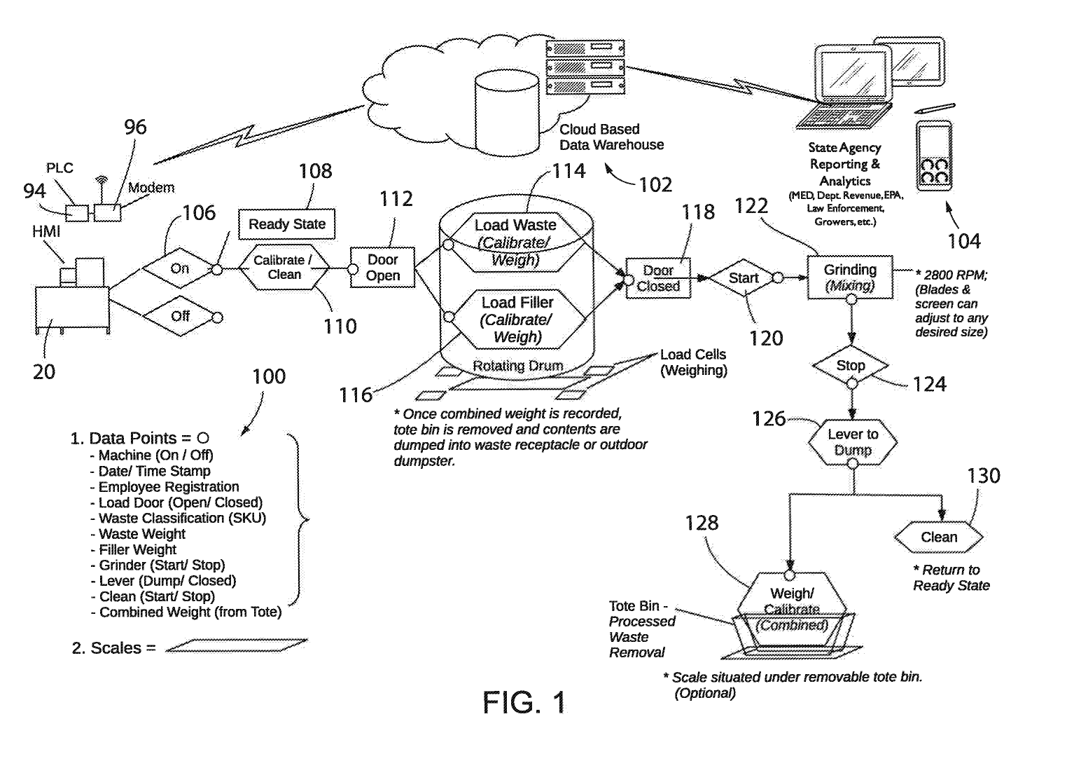

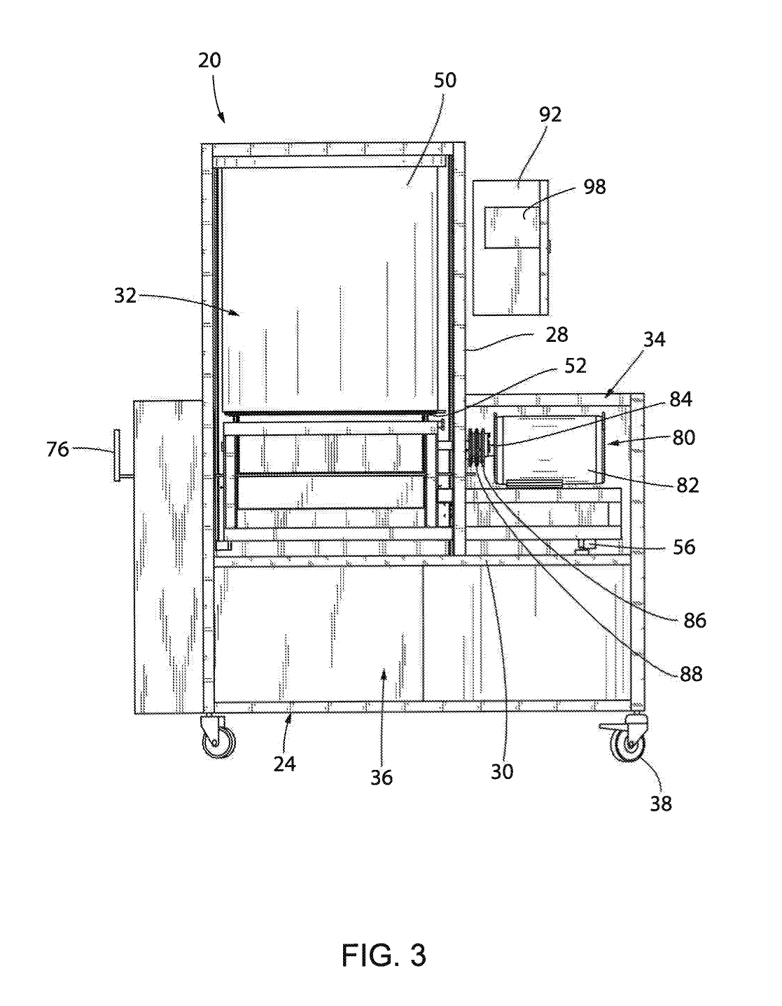

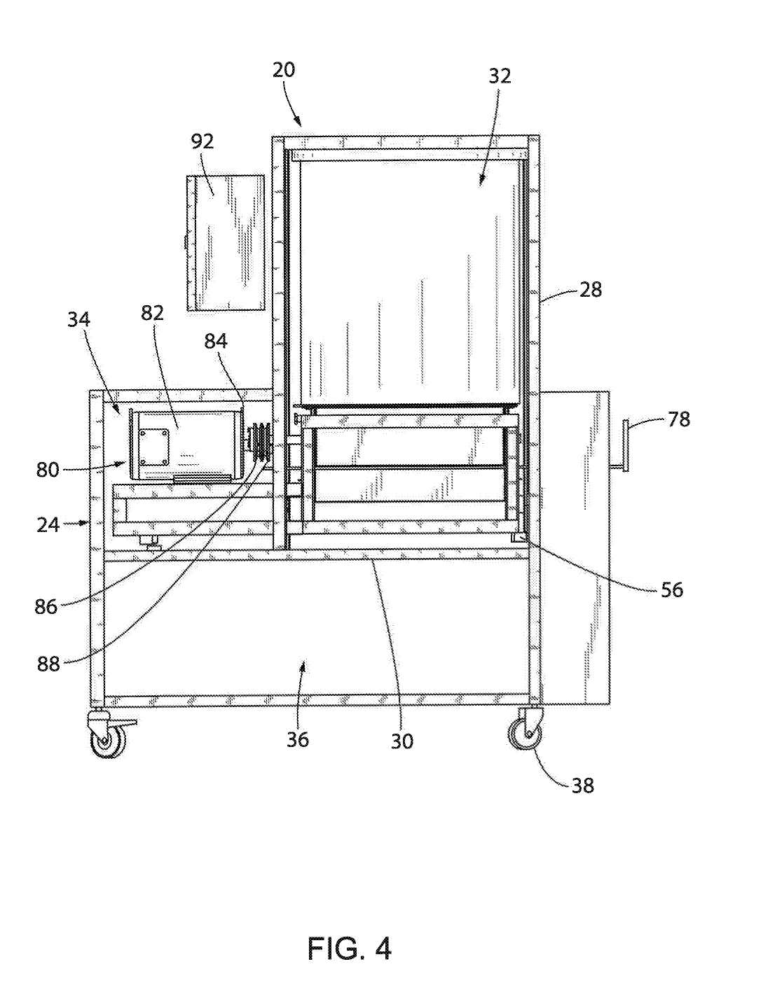

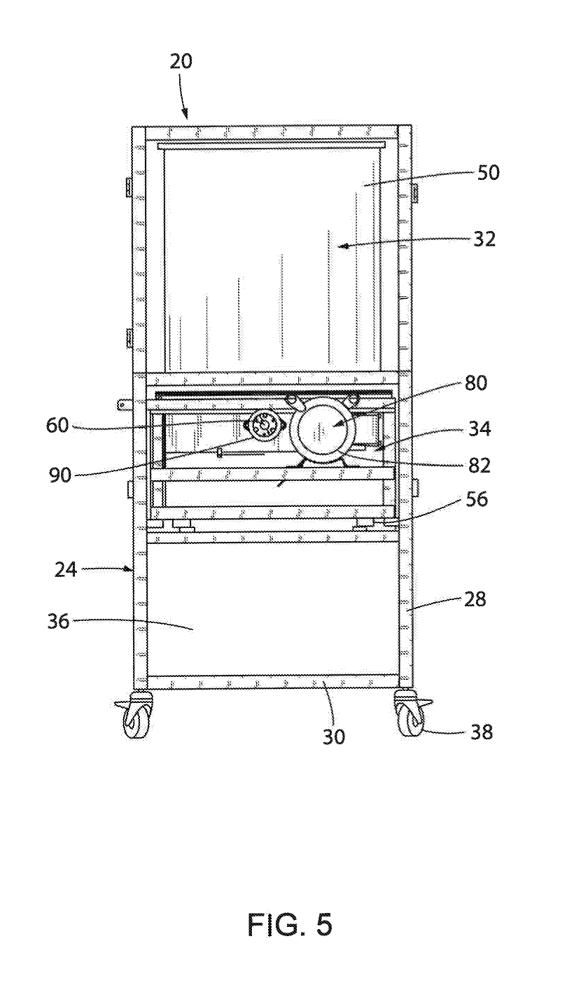

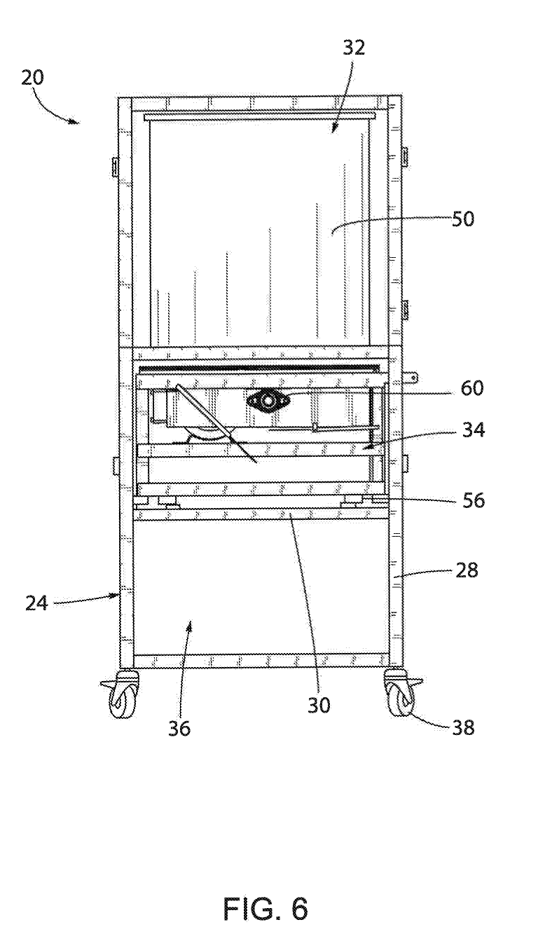

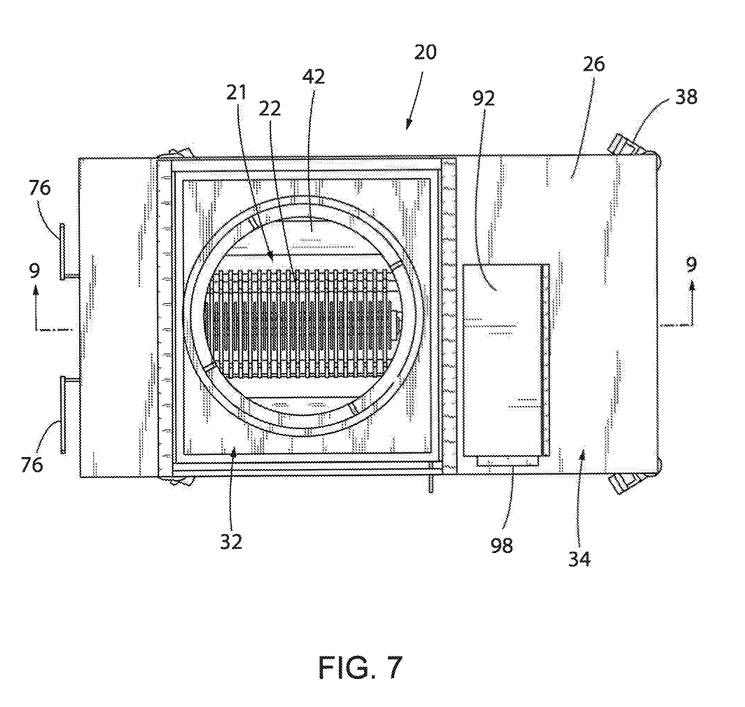

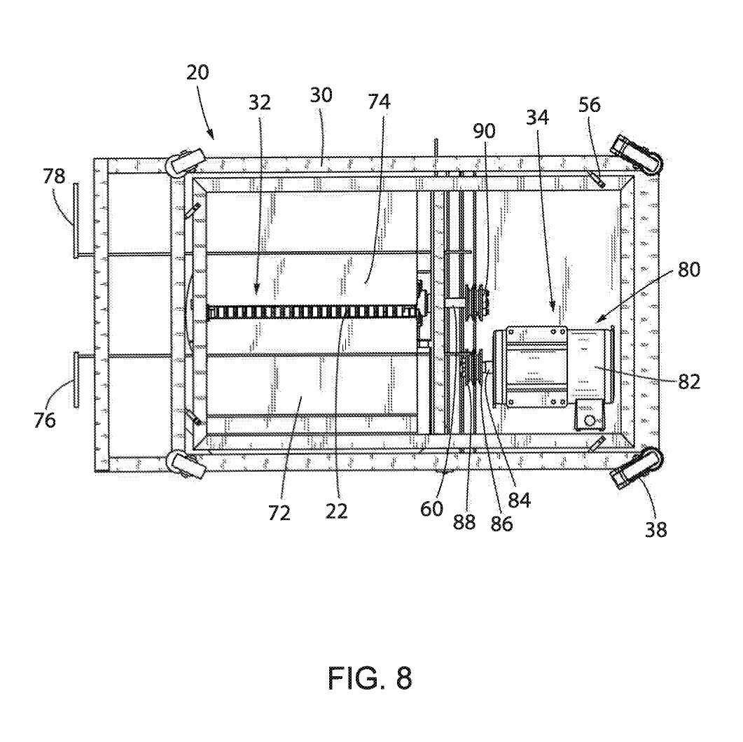

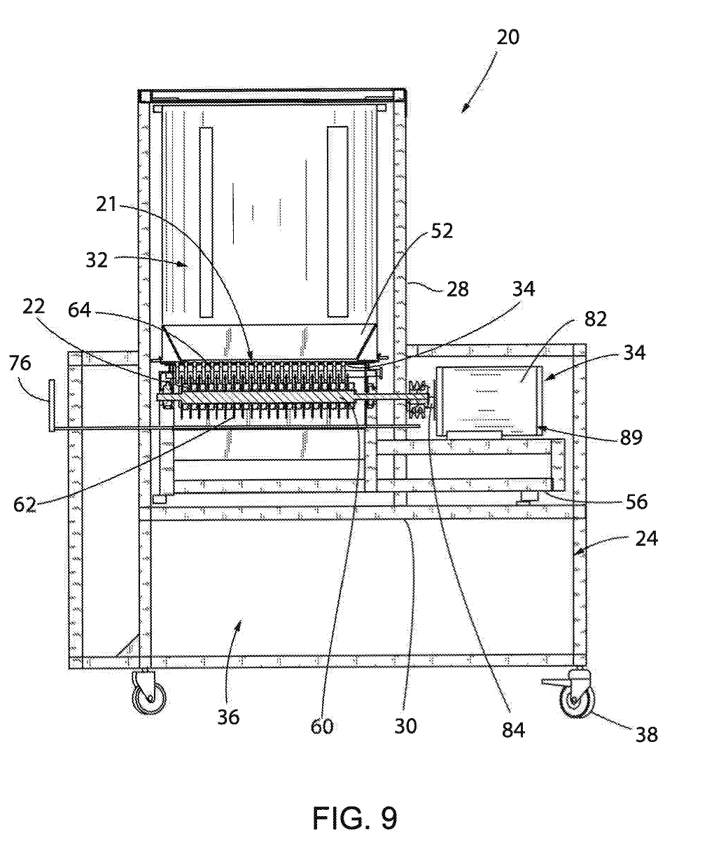

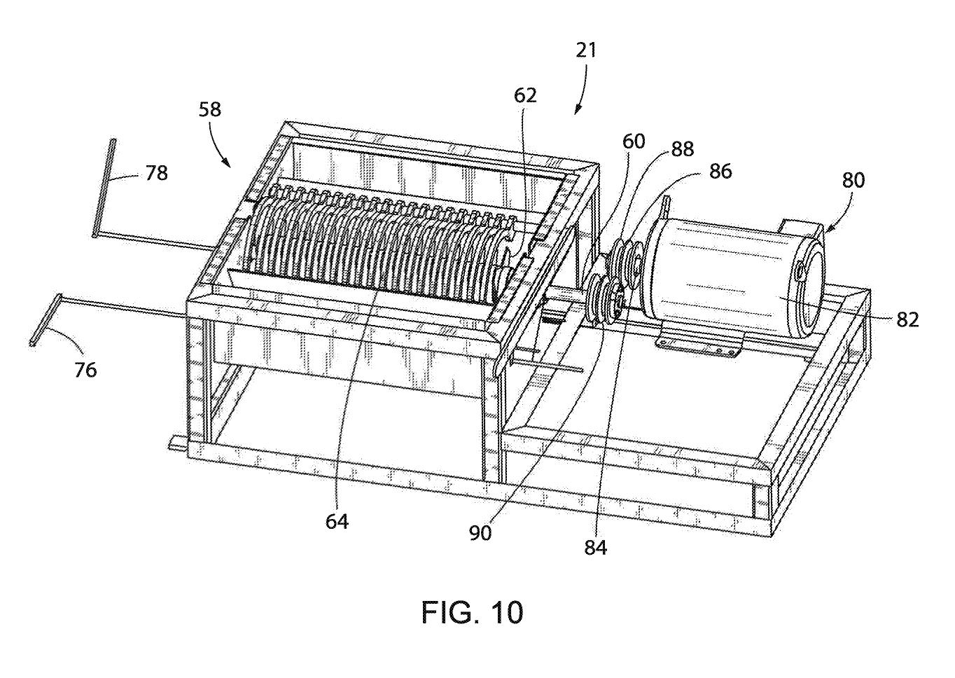

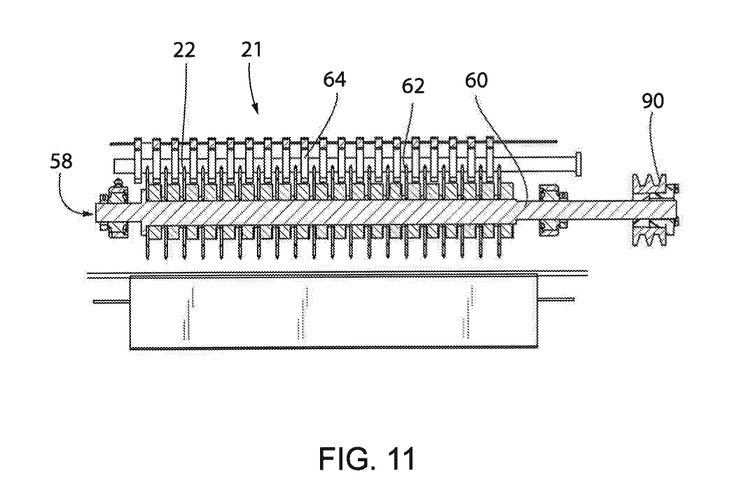

FIGS. 1-12 illustrate a system and method involving a waste and filler blending machine 20 configured to dilute a quantity of waste material with a filler material while rendering the waste material unusable and unrecognizable and of documenting compliance with in order to comply with applicable regulations. Referring to the functional flowchart of FIG. 1, initially, a quantity of waste material and a quantity of filler material are added to the machine 20, after which the materials will be ground and blended using a blender 21 formed from a grinder 22 and an overlying rotating drum 50 to form an amorphous mixture of ground waste and filler. The combination of these materials, and more specifically the dilution of the waste as a designated proportion on a mass-basis, will be monitored and documented to provide evidence of compliance with relevant regulations. The system is first readied for operation as seen in items 94-112 and loaded with designated proportions of waste and fillers as seen in items 114-118 before the waste and fillers material are ground and mixed and then discharged into an underlying receptacle as seen in items 118-126. These and other aspects of the process will be described in greater detail below after the blending machine 20 is described in greater detail.

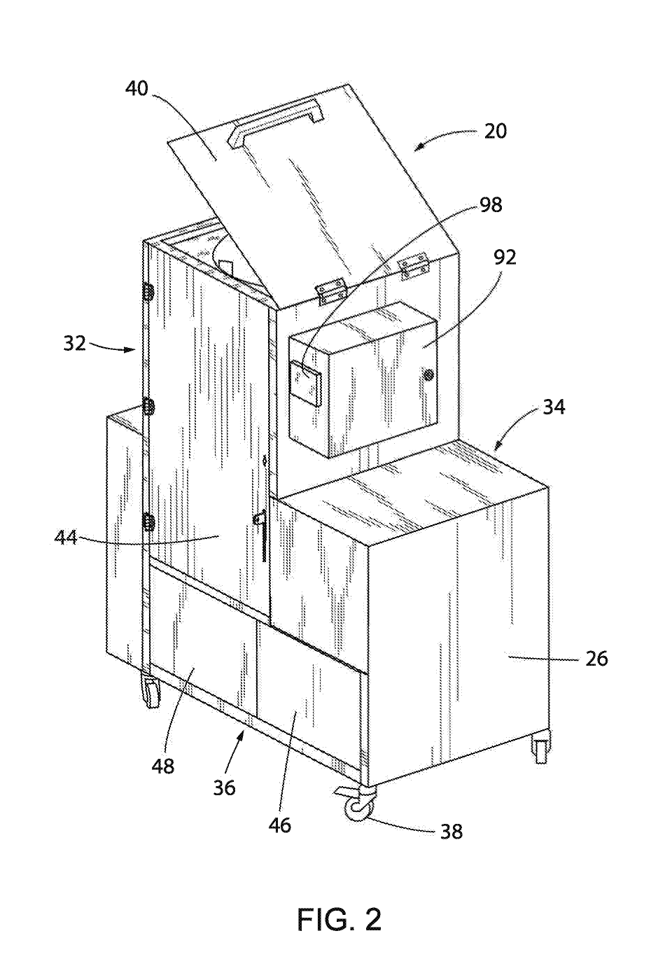

Turning next to FIGS. 2-11, the illustrated waste and filler blending machine 20 includes a frame 24 and a plurality of exterior cladding panels 26 mounted to the frame 24. As shown, the frame 24 includes a plurality of vertical posts 28 mounted to a plurality of horizontal rail segments 30, such that the frame 24 consists of a plurality of rectangular sections. Among others, the rectangular sections of the illustrated embodiment include a drum section 32 located towards the top of the machine, a motor section 34 located adjacent to the drum section 32, and a storage section 36 located beneath the drum section 32 and the motor section 34. Of course, the specific locations of these sections could vary as desired, and additional sections could similarly be included to house other components. These posts 28 and rail segments 30 may be steel square tubing segments to ensure that the machine 20 has a high durability. The vertical posts 28 and horizontal rail 30 segments may be welded together, attached using various bolts, screws, or other fasteners, or otherwise secured to one another as known to one of ordinary skill in the art.

The panels 26 are mounted to the vertical posts 28 and horizontal rail segments 30 on the front, back, first side, second side, third side, fourth side, top, and bottom of the machine 20. As shown, these panels 26 are stationary panels made of heavy gage sheet metal that are securely attached to the frame 24 using screws or bolts. Because these panels 26 are securely attached to the frame 24, a user cannot access the interior of the frame 24 through these stationary panels 26. Additionally, the panels 26 may be cross-broken to enhance rigidity and help dampen vibrations when the machine 20 is in use. The machine 20 may also include a plurality of lockable wheels 38 mounted to the bottom of the machine 20 to allow the machine 20 to be easily moved from one location to another.

The machine 20 may also include a number of lids or doors. For instance, the machine may include a top lid 40 that is located on the top of the machine 20. The top lid 40 may be opened and closed to access a top opening 42 of the drum section 32, allowing a user to access the interior of the drum section 32 from the top, as will further be described below. For instance, the top lid 40 may be of a “mailbox” style design, which allows material to be inserted into the machine 20, but which prevents users from reaching into the machine 20 for safety reasons and to prevent the removal of materials located within the machine 20. Additionally, a drum door 44 may be mounted to the front of the machine 20. The drum door 44 may be rotatable relative to the machine 20 to expose a front opening in the drum section 32 to access the drum section 32. The drum door 44 allows a user to access the interior of the drum section 32 from the front, for instance, to clean the interior of the drum section 32 or otherwise provide maintenance on the interior of the machine 20. Additionally, multiple doors may be arranged relative to the storage section 36. More specifically, as shown, a first stationary door 46 and a second sliding door 48 may be mounted to the front of the machine 20 adjacent to the storage section 36. The sliding door 48 may be slid relative to the stationary door 46 to permit access of the storage section 36, as will further be described below. Any of the lids and doors may have electronic interlocks or physical locks (not shown) to prevent movement of the lids and doors during operation of the machine 20.

A number of components may be located within the machine 20. For instance, the drum 50 and grinder 22 may be mounted within the machine 20, and more specifically within the drum section 32. As shown, the drum 50 is cylindrical in shape and may include a lower tapered section 52, which tapers inwardly towards an exit opening 54 located in the bottom of the drum 50 directly above the storage section 36. The drum 50 is rotatable relative to the machine 20 in a clockwise or counter-clockwise direction about a vertical axis extending through the center of the drum 50. For instance, a wheel (not shown) may be mounted to a portion of the drum 50, which facilitates rotation of the drum 50. This rotation of the drum 50 helps to move the waste and filler materials downwardly towards the grinder 22. Additional mechanisms such as spring-loaded or manually-operated press may be included in the drum 50 to further encourage movement of the waste and filler material downwardly toward the grinder 22, such as a spring-loaded lever (not shown).

The machine may also include a mechanism for weighing the drum. For example, a number of load cells mounted around the drum section 32. In the illustrated embodiment, four load cells 56 may be mounted on the horizontal rail sections 30 at the bottom of the drum section 32. These load cells 56 are configured to measure the weight of the drum section 32 and thus of weight of materials within the drum 50. More specifically, these load cells 56 can measure the weight of waste material that is inserted into the drum section 32 by monitoring the weight increase of the drum section 32 after loading is complete. Once this measurement has occurred, filler material can also be deposited into the drum section 32, and the weight of the loaded filler can be measured by the load cells 56 by monitoring the change in weight of the drum section 32. Thus, the measurements provided by the load cells 56 help to ensure that appropriate weights of the both the waste material and the filler material are added to ensure compliance with appropriate regulations. Configuring the load cells in this manner isolates the weight materials from other system components, including the bin dumping mechanism, and produces more accurate measurements.

The grinder 22 can also be mounted within the drum section 32. As shown, the grinder 22 is located directly beneath the exit opening 54 in the drum 50. The grinder 22 has a single rotor assembly 58 with a rotor shaft 60 and blades 62 extending therefrom, and a cage 64 locate adjacent to the blades 62. As the single rotor assembly 58 is rotated about the rotor shaft 60, the blades 62 rotate relative to the cage 64. As a result, the waste and filler materials may be held by the cage 64 and then chopped by the blades 62.

Alternatively, the grinder 22 may include multiple rotor assemblies (not shown), for instance a first rotor assembly and a second rotor assembly. In this alternative configuration, these rotor assemblies may be rotated by a central rotor axle. The first rotor assembly includes a first rotor shaft (not shown) having a first plurality of rotor blades, and the second rotor assembly similarly includes a second rotor shaft and a second plurality of rotor blades (not shown). Each rotor shaft of this embodiment can be rotated in opposite directions to result in the movement of the waste material and the filler towards the center of the drum section 32.

During operation, the rotor shaft 60 or shafts may be rotated at a speed of 2,800 rotations per minute, although the speed could be varied depending on a number of factors including the specific configuration of the blades, the type of waste and/or filler material, and the desired consistency of the mixture of the materials. To ensure the materials are properly blended, the grinder blades 62 may be rotated relative to the cage 64 until the materials have been chopped to a desired size, after which the mixture can drop down through openings formed in the cage 64. Where the grinder includes multiple rotor assemblies, the first plurality of rotor blades and the second plurality of rotor blades may be rotated inwardly towards one another such that the waste material and the filler accumulate at the center of the grinder 22, after which the materials will be ground and/or shredded and mixed together through the grinder blades.

Additionally, a filter or sizing screen (not shown) may be located immediately beneath to the grinder 22 to ensure that the materials have been ground to an appropriate size. Where the pieces of material are too large to fit through the filter or screen, they can be recirculated through the grinder 22 to grind and/or shred the pieces to a smaller size. After the grinding procedure has been completed, the ground material can fall downwardly towards the storage section 36.

Also, one or more gates may be installed within the drum section 32 directly beneath the grinder 22 to control the dumping of blended material into the underlying storage section 36. The illustrated embodiment includes a first gate 72 and a second gate 74. The first gate 72 and the second gate 74 are configured to catch the waste and filler mixture before it is dropped into the storage section 36. These gates 72, 74 help to ensure that the total mass materials in the drum 50 is appropriately measured, including small particles, before any materials are dropped into the storage section 36. A first lever 76 may extend from the first gate 72 and a second lever 78 may extend from the second gate 74. The user can activate the respective levers 76, 78 to manually drop the gates 72, 74 from a closed position to an opened position once the mixture process is completed. Similarly, spring-loaded levers (not shown) may be used to make it easier to move the gates 72, 74 from a closed position to an open position, and thereafter from the open position to the closed position. Further still, the gates 72, 74 could be configured to automatically drop when a desired quantity of mixture is achieved.

Additionally, a motor 80 is mounted within the motor section 34 of the machine 20. The motor 80 has a motor body 82 with an axle 84 extending therefrom with at least one pulley. As shown, the axle 84 includes a first pulley 86 and a second pulley 88. A drive belt or drive belts associated with the pulley or pulleys may be used to transfer rotational movement from the motor axle 84 to other pulleys. For instance, as discussed above, the wheel associated with the drum 50 may be rotated by a first drive belt (not shown) that extend from the first pulley 86 to the wheel. In this way, rotation movement of the motor axle 84 results in rotational movement of the drum 50 about the vertical axis extending through the center of the drum 50. Similarly, a second drive belt (not shown) can extend from the second pulley 88 to a first grinder pulley 90. As a result, the grinder pulley 90 allows the shaft 60 to be rotated relative to the cage 64 to facilitate the mixing and grinding of the waste material and the filler material. Although a single motor 80 is shown, it should be appreciated that the machine 20 may also have multiple motors, for instance one motor that rotates the drum 50 and another motor that rotates the grinder blades 62. Further still, although the illustrated motor 80 includes a first pulley 86 and a second pulley 88, the motor 80 may only feature a single pulley, which transfers rotational motion to a first pulley associated with the rotor shaft 60. In such an embodiment, the rotor shaft 60 may have at least one additional pulley, and possibly more pulleys, that transfer rotational motion to the wheel, the drum 50, or other components of the machine 20.

Turning next to the storage section 36, a receptacle such as a tote or other container (not shown) can be removably inserted directly beneath the drum section 32. This tote or container is configured to collect the waste and filler mixture after being ground. It may have a capacity that is sufficiently low to be carried manually away from the machine. Tote capacities of between 25 lbs. and 50 lbs. and, more typically, 30 lbs. to 35 lbs. are typical. To access the tote, the slidable door 48 is slid relative to the stationary door 46. Thereafter, the tote can be removed from the storage section 36 and properly disposed of. The storage section 36 may also include additional load cells mounted about the storage section 36. For instance, four additional load cells (not shown) may be mounted within the storage section 36 to measure the contents of the storage bin. In this way, the weight of the ground mixture can be compared to the measured weight of waste material and filler material in the drum section 32 to ensure all of the materials have been ground to ensure compliance with relevant standards.

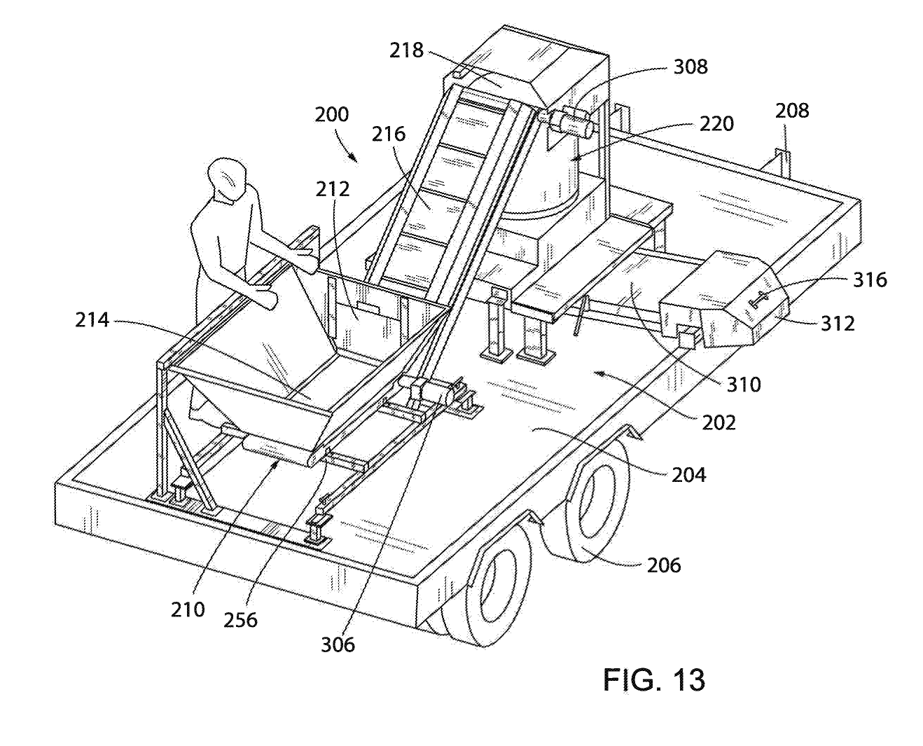

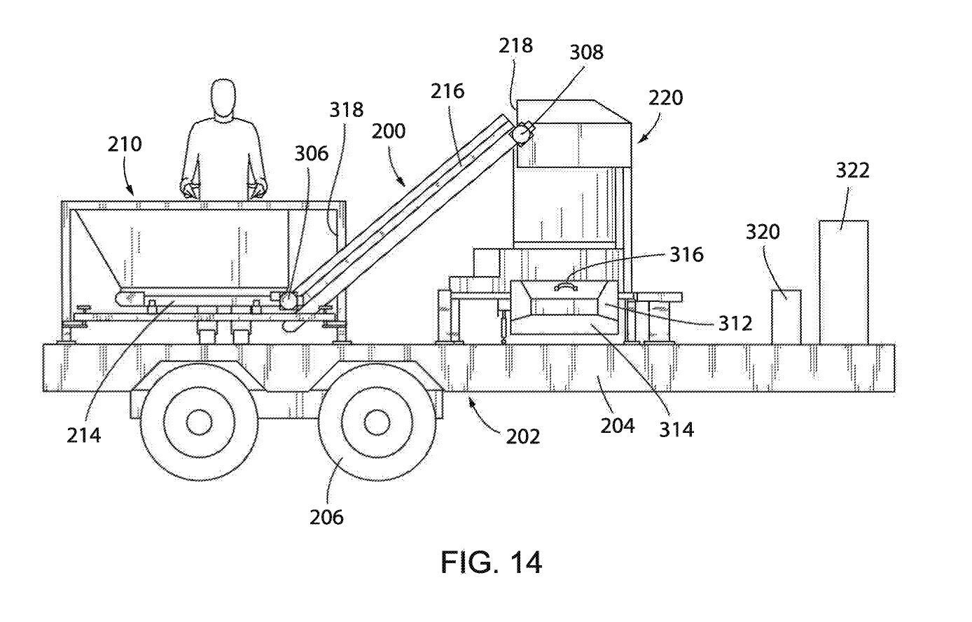

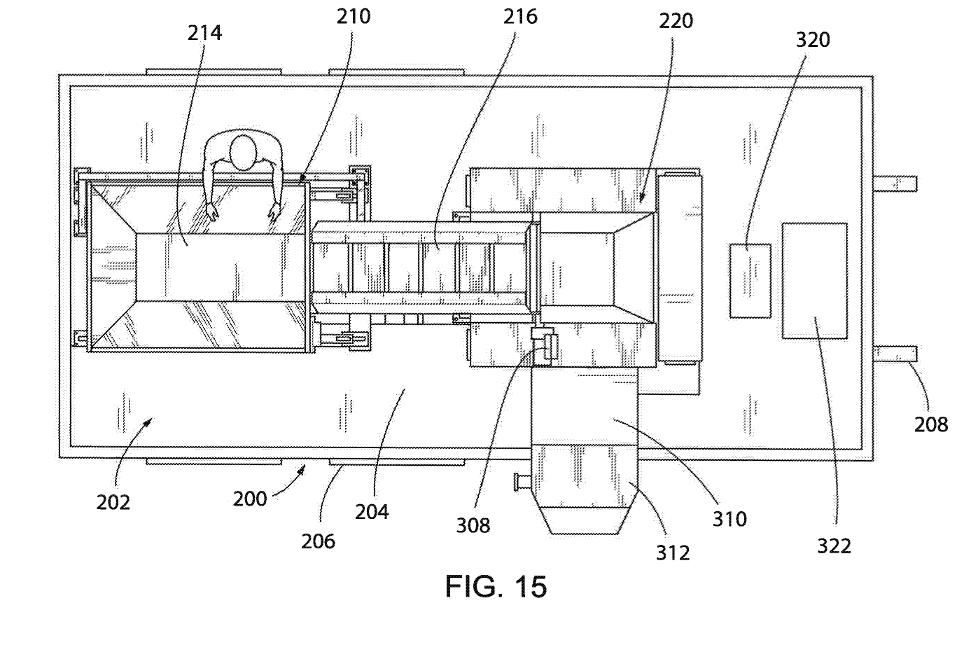

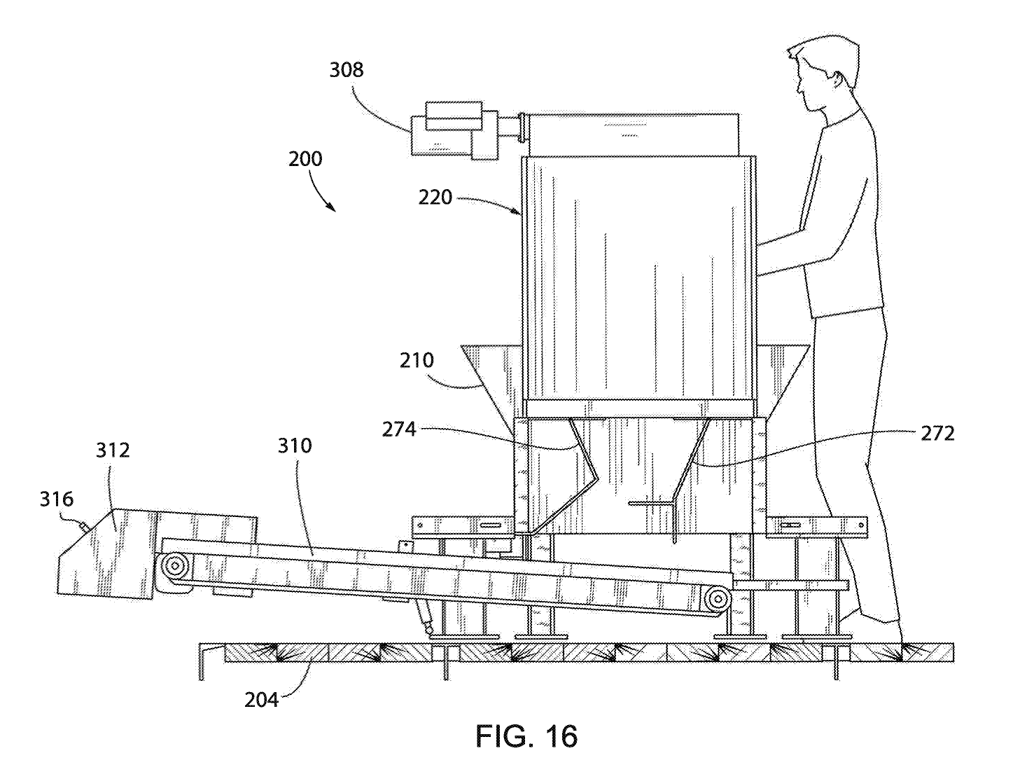

It should be noted that the storage section 36 could be configured to receive any of a variety of manually transportable or propelled receptacles for receiving the ground and mixed materials from the drum section 32, along with any of a variety of manually operated, partially automated, or fully automated devices for transporting the receptacle or the materials away from the machine 20 and, potentially, even of disposing of those materials. For example, a tote or other receptacle (not shown), and its attendant load cells (if present) could be spaced from the blender 21 and receive the blended materials from the blender 21 via a conveyor. The resultant remote receptacle could be used, for example, with either a blender 21 constructed in accordance with this embodiment or a blender (not shown) located within the machine 220 constructed in accordance with the mobile embodiment of FIGS. 13-17.

The system may also have a control box 92 mounted to the machine 20. As shown, the control box 92 is mounted to the side of the drum section 32. The control box 92 may house an electrical panel with a computer system 94, such as a programmable logic controller, a RAM, a ROM, a digital processor, or any combination thereof. Additionally, the electrical panel may include cables, lockable disconnect switch/main breaker connections, a distribution panel with breakers for the grinder motor, and other instruments. The computer system may connect wirelessly to a cloud-based electronic warehouse by a modem 96, which allows for the remote storage of information collected related to use of the machine 20. Instead of or in addition to communicating with a cloud-based warehouse, the computer could communicate directly with a third party's computer. In either event, data transfer from the computer system 94 to the recipient preferably is secure and encrypted.

Additionally, a human-machine interface (HMI) 98 may be mounted to the control box 92. The HMI 98 is in communication with the computer system. For instance, the HMI 98 may be a touch screen that allows a user to operate the machine 20 and input relevant information. More specifically, the HMI 98 may allow a user to input various information that is relevant to the dilution of the waste with the filler. That information and information derived from it then can be saved in a memory of the computer system 94 and/or uploaded to a remote database such as the cloud or a third-party database. Potential information that could be input into the HMI 98 and saved to the on-board or remote database cloud include a user's identification information, a machine's identification information, identification information relating to the waste material, identification information relating to the filler material, information relating to a required dilution percentage, and the like. Additionally, an amount of commercial yield associated with the waste product could also be input into the HMI. This could permit growth analytics to be calculated, as will be further described below. Any of these inputs may be manually typed in, or SKU numbers or other identification numbers may be assigned to simplify the input process. Information also could be entered using bar codes, QR codes, or any other automatic or semi-automatic data transfer mechanism(s). Additionally, information may automatically be assigned, including a time and date stamp. Of course, additional aspects of the machine 20 can be controlled by the HMI 98.

In addition to collecting information described above, the computer system 94 may also monitor a number of data points represented by reference numeral 100 about the machine 20 using various sensors. These data points 100 can include the weight of the waste material loaded into the drum 50, the weight of the filler material loaded into the drum 50, and the combined mass/weight of the waste material and the filler material. Further still, the computer system may monitor various run times, including when the machine 20 is turned on and when the machine 20 is turned off, when the grinder 22 is turned on and when the grinder 22 is turned off, when the levers 76, 78 are pulled to open the gates 72, 74 and when the gates 72, 74 are returned to the closed position, and when a cleaning cycle starts and ends. All data points 100 that are monitored can be compared to historic data, which can expose any discrepancies that could indicate whether tampering has occurred that could compromise compliance.

In addition to the machine 20 itself, the inventive system allows operation of the machine 20 as a whole and its specific components to be monitored, controlled, and documented. For instance, the computer system 94 can limit access to various components of the machine 20 by activating a series of electronically-controlled locks. More specifically, the various doors, lids, and the like may be configured to only be accessible at certain times. For instance, once the waste material and the filler material have been inserted into the drum 50 through the top opening 42 and the lid 40 has been closed, the lid 40 may be configured to be locked or otherwise held shut until the grinding process has been completed and the mixture has been dropped into the storage section 36. Similarly, movement of the sliding door 48 in the storage section 36 can be restricted after the storage bin has been inserted until the grinding process has been completed and the mixture is dropped into the storage section 36. Further still, the drum door 44 may be controlled to remain locked during the entire process to restrict access directly into the drum 50. Additionally, operation of the machine 20 may be disabled in the event that any of the doors or lids remain opened, and the machine 20 may only be operational once all doors or lids are securely closed and locked. This limited access serves two primary purposes. First, limiting the access inside of the machine 20 helps to ensure that relevant regulations are complied with and that users are not capable of tampering with the waste material once it has been inserted into the machine 20. More specifically, if individuals cannot easily gain access to the interior after the waste material has been inserted, it is easier to confirm compliance with relevant regulations relating to the dilution of the waste material. Additionally, since the use of the grinder 22 includes grinder blades 62 rotating at a rapid speed, the limited access helps to ensure the safety of users located around the machine 20.

The various information collected by the computer system is transmitted to the cloud-based data warehouse 102 or directly to a third-party server, and can thereafter be transmitted to other computers, smartphones, tablets, 104 and the like. This information can be transmitted to the owner or generator of the waste material, the relevant local, state, and federal regulation authority, and any other entities who would need to review this information. The information can be reported out as raw data in a spreadsheet or other document, or it may be shared in a computer application. Additional analytical information can similarly be provided. The specific output can be customized based on the desire of a given user.

Looking again to FIG. 1, operation of the system will now be described. Initially, the machine 20 will be powered on using the HMI 98, as shown in box 106. After the computer and associated components have booted up, the machine 20 will be in a ready state as identified in box 108. Once the machine 20 reaches the ready state, the machine 20 can be calibrated to confirm that the drum 50 is empty, as shown in box 110. In this step, the load sums are zeroed out, and the computer system confirms that the machine 20 is ready for use. A bin or storage container can then be inserted into the storage section 36, and the sliding door 48 can be closed and locked. Next, the top lid 40 is opened, as shown in box 112. After the lid 40 is opened, a quantity of waste material is loaded into the drum 50 through the top opening 42, as shown in box 114. The specific weight of waste material can be determined based on the weight dumped into the drum 50 by the user. Alternatively, a desired weight of either waste material, or the weight of the overall mixture, can be entered into the HMI 98. After the information has been input into the HMI 98, the computer system can generate a countdown scale that allows the user to visualize when the appropriate weight of waste has been added, or the computer system may generate a visual or audible indicator that informs a user that the desired weight of waste material has been added to the drum 50. The waste material may be loaded manually by a user or it may be delivered to the top opening 42 using a conveyor or other automated device. The load cells 56 measure the weight of waste material that is deposited and transmit such measurements to the computer system 94. The computer system may then display the measurements on the HMI 98 and also store the resulting readings in its internal memory and/or transmit the readings to the cloud-based data warehouse 102 for future reference to confirm compliance. Of course, the readings could similarly be stored in a removable memory stick, any peripheral memory source, cloud storage or any other memory device coupled or wirelessly connected to the computer system. Once this is done, the user submits confirmation that loading of the waste material has been completed using the HMI 98.

After all of the waste material has been added to the drum 50 for a given load and the same has been recorded, the filler material may be inserted, as shown in box 116. The computer system may calculate the weight of filler material that must be inserted in light of the dilution percentage required by the regulation and the measured weight of waste material that has previously been added to the drum 50. For example, if the desired dilution percentage is 51%, meaning it is desired to assure that the mixture contains a minority of waste material, and the user has input 18.5 lbs. of waste material into the drum, the computer will calculate a desired weight of filler material of 18.7 lbs. to be added to drum 50. This information can be communicated to the user as a total weight of filler material that must be inserted, as a countdown scale that allows a user to visualize when the appropriate weight of filler has been added, or as a visual or audible indicator that informs a user when the desired dilution percentage has been achieved. In one implementation, the computer system 94 controls the system such that, until the appropriate weight of filler material deposited into the drum 50 has been reached or exceeded, the lid 40 cannot be locked, and the grinder 22 cannot be turned on. During this process, the load cells 56 measure the weight of filler material that is inserted into the drum 50, and the computer 94 stores the determined weight in its internal memory and/or transmits such information to the computer system.

Of course, the filler material could similarly be added first, followed by the waste material. In fact, the operator can add the waste and filler materials in any amounts (within the capacity of a given system), in any order, in any number of times, so long is the net result is the formation of a combined mass meeting the desired dilution requirements.

Once the contents of the drum 50 have been confirmed, the top lid 40 can be closed, as shown in box 118. This can manually be done by a user, or it may automatically occur by the computer system using a hydraulic or spring-loaded lid. After the lid 40 is closed, all of the doors and lids are locked in place, either manually or automatically, to prevent access to the interior of the machine 20. Once the machine 20 has been locked, the user may initiate use of the grinder 22 using the HMI 98, as shown in box 120. Grinding and mixing then commences, as shown in box 122. As the grinder blades 62 rotate relative to the cage 64, the drum 50 will rotate in a clockwise or counter-clockwise direction about the vertical axis extending through the center of the drum 50. Because of gravity as well as the shape of the drum 50, including the lower tapered section 52, the waste material and filler material will naturally be funneled downwardly toward the grinder 22. Once the waste material and filler material have been sufficiently ground, the mixture can pass through the filter and onto the gates 72, 74. The grinder 22 is then stopped, as shown in box 124.

After the grinding process has been completed and the weight of the mixture has been measured by the load cells 56 and recorded with the computer system, the levers 76, 78 can be activated to open the gates 72, 74, as seen in box 126, resulting in the dropping of mixture into a bin or bins located within the storage section 36. The load cells of the storage section 36, if present, can measure the weight of mixed waste and filler material to ensure that all of the materials added to the drum section 32 have been ground and deposited in the tote, as shown in box 128. Thereafter, once the machine 20 has been turned off, the sliding door 48 can be unlocked. Subsequently, the user can slide the sliding door 48 to expose the tote. The tote can be removed, and its contents disposed of, as acceptable under the relevant regulation. If needed, the machine 20 can then be cleaned, as shown in box 130. Final measurements and other data collected by the machine 20 are then transmitted to the cloud-based data warehouse 102. The measurements and data can then be displayed on various computers, tablets, smartphones 104 and the like. Of course, the steps outlined above need not occur in the specific order outlined above.

By keeping track of the various data points 100 described above, this system allows the chain of custody of the waste material to be traced during the entire dilution process. The system also allows for real-time data collection and accurate reporting of the grinding process to ensure sufficient documentation is collected to provide sufficient evidence of compliance with relevant regulatory provisions.

The system also allows for growth analytics to be generated that compare the weight of commercial yield, which is usable product that was previously associated with the waste material, to the weight of the waste material. For instance, specific types of products having a higher ratio of commercial yield to waste product can be identified. This would allow producers of the product to evaluate which materials result in a large commercial yield to maximize usable product and minimize waste material for future batches

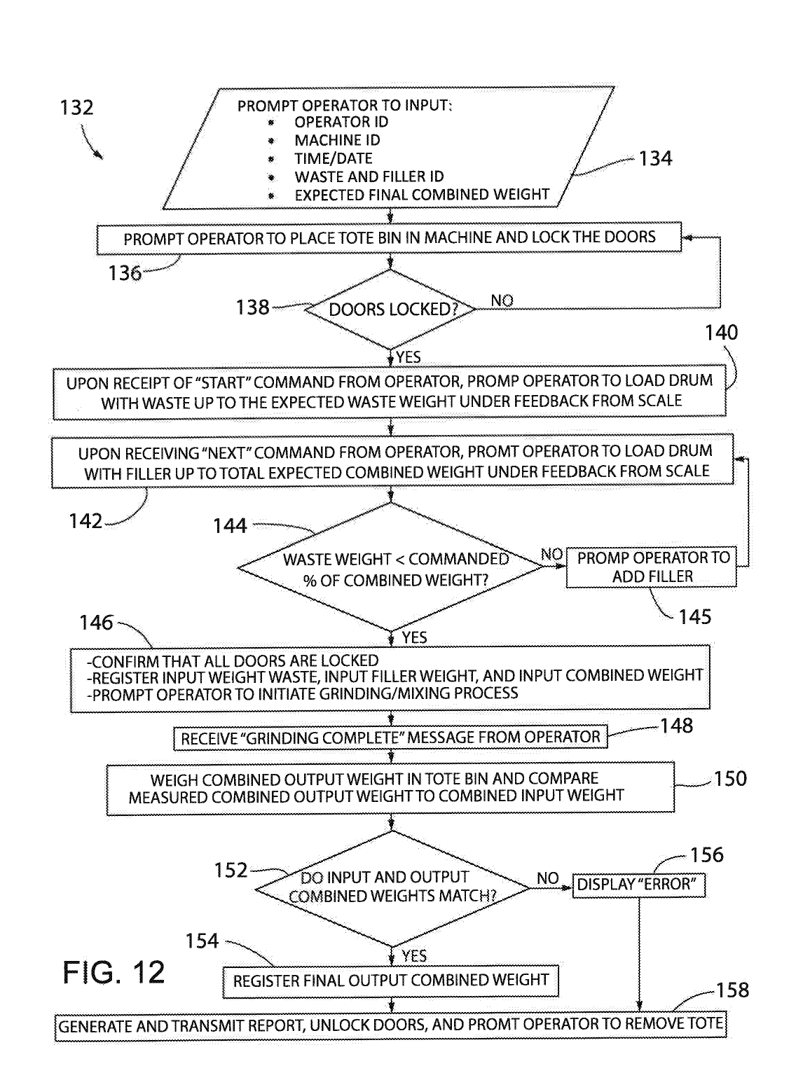

Referring now to FIG. 12, a flowchart 132 illustrating a series of steps to be performed in a method for managing waste and demonstrating compliance with applicable regulations is shown, according to an exemplary embodiment. This flowchart 132 can be thought of as viewing the process from the vantage point of the computer system 94. In step 134, the user inputs various identification information into the HMI 98, which are transmitted to the computer system 94 and stored in its memory and/or uploaded. These can include an operator identification number, a machine identification number, a time and date stamp, a waste identification number, filler identification number, and an expected final combined weight. Next, in step 136, the operator is reminded to place the storage bin or tote into the storage section 36 of the machine 20. Thereafter, in step 138, the process checks to determine whether the sliding door 48 is locked. If the sliding door 48 is not locked, step 138 is repeated. Once it is confirmed that the door 48 has been locked, the computer system confirms that the user has submitted a start command to the HMI 98, after which the computer monitors loading of the drum 50 with waste up to the desired weight, such as about half, of the total expected weight of the combined materials, as shown in step 140. The computer system 94 will monitor the supply of waste material to the drum at this time as discussed above in connection with FIG. 1. The computer system 94 then confirms that the user has selected a next command on the HMI 98, and that the user has loaded the drum 50 with the filler material up to the expected weight based on feedback through the HMI 98, as shown in step 142. In step 144, the weight of waste material is compared to the total weight of material. If the waste material is not sufficiently diluted, such as if the waste material accounts for more than half of the weight of material, the computer system 94 prompts the user to add additional filler material in step 145, and step 142 is repeated. Once the desired dilution level is reached, step 146 requires that all doors are locked, after which the various readings from the load cells 56 are recorded, and computer system 94 confirms that the user provides a command through the HMI 98 to initiate the grinding and mixing process.

After that, under step 148, a grinding complete message is delivered to the user. Next, load cells in the storage section 36 measure the weight of mixture received in the storage bin as shown in step 150. Under step 152, the input weight and output weight are compared. In the event that the input weight matches the output weight, under step 154, a final output of the combined weight is registered. In the event that the input weight does not match the output weight, an error is displayed under step 156. Finally, in step 158, a report is generated and transmitted, the various doors are unlocked, and the operator is prompted to remove the tote.

Another embodiment of the machine 220 is shown in FIGS. 13-16. Many of the same features described above are similar, if not identical, to those described above for the machine 20. These components are designated by the same reference characters as the components of the machine 20 of FIGS. 2-11, incremented by 200. FIGS. 13-16 show a portable system 200 with the machine 220 mounted thereto. As shown, the system is located on a portable trailer 202 including a bed 204, tires 206, and at least one hitch 208 that can be secured to a truck or other vehicle (not shown). In this way, the system 200 can easily be transported from location to location for the on-sight dilution of waste materials. Of course, the system 200 also could be rendered portable in other ways, such as by being mounted on the bed of a truck.

The system 200 differs from the system 20 of the first embodiment primarily in that the machine is simplified in several respects and materials are supplied to the blender by a weighed hopper 210 and a conveyor rather 216 than by being loaded directly into a drum above the blender. Nevertheless, the system of this embodiment is capable of monitoring the blending of materials and reporting compliance in at least generally the same manner as the system 20 of the first embodiment.

As shown, the system 200 includes a hopper 210 that is mounted to the top of the bed 204. The hopper 210 takes the form of a storage bin into which a user can deposit both the waste material and the filler material. Like the drum section of FIGS. 2-11, the hopper 210 may have at least one load cell 256 located adjacent to the bottom of the hopper 210 to enable weighing of materials in the hopper 210. The hopper 210 may also have a security gate 212 formed in one of its ends. The security gate 212 that selectively closes an outlet or discharge opening 318.

Additionally, the system 200 may include a number of different conveyors. As shown, a hopper conveyor 214 may be located in the bottom of the hopper 210 for transporting materials out of a discharge opening 318. A second conveyor 216 that extends from the discharge opening 318 of the hopper 210 where the gate 212 is located to an entrance opening 218 formed in the machine 220. The conveyor 216 could be a driven belt as shown, an auger, or any other device or combination of devices capable of conveying materials from the hopper 210 to the machine 220. In this way, once the hopper 210 has been loaded with the waste and filler material and the weight of the combined materials have been recorded, the gate 212 can be opened. Thereafter, a hopper conveyor 214 such as a belt can be driven to transport the waste and filler materials from the hopper 210 through the discharge opening 318 to the second conveyor 216. From there, the second conveyor 216 delivers the waste and filler materials to the entrance opening 218 in the machine 220. As shown, the entrance opening 218 is located at the top of the machine 220 such that gravity helps to ensure that the waste material and the filler material are properly deposited into the machine 220. Motors 306, 308 are located about the system 200 to power the hopper conveyor 214 and the second conveyor 216. Additionally, a mobile generator 320 may also be mounted to the trailer 202 to power the various motors 306, 308, as well as the machine 220. Further still, a control box 322 containing a computer system similarly be mounted to the trailer 202. The computer is configured to control operation of the various components of the system 200, including the hopper 210 and the blender, as well as to monitor and document combining of the waste and filler materials and the blending of the two.

Operation of the machine 220 of FIGS. 13-16 is substantially the same as operation of the machine 20 of FIGS. 2-11. More specifically, a grinder (not shown) is used to grind the waste material and the filler material with one another to dilute the waste material such that the waste material is rendered unusable or unrecognizable as required by relevant regulations. The grinder may be functionally and even structurally identical to the grinder of the first embodiment. The machine 220 may also include a rotating drum (not shown) and a cage (not shown) that may be functionally or even structurally identical to the drum and gates of the first embodiment. The machine 220 may have a scale such as various sensors or load cells mounted therein to monitor the weight of the various components and ensure that no materials are unaccounted for. Additionally, the machine 220 may also have first and second guide chutes 272, 274 that help to guide the blended material from the machine 220 towards a conveyor 310 that will further be described below.

Once the waste material and filler material have been appropriately blended by being mixed and ground in the blender, the resultant mixture can be removed from the machine 220. For instance, as shown the system 200 may also include a discharge conveyor 310 such as a belt conveyor. The blended material conveyor 310 is located at the bottom of the machine 220. As such, once the waste material and filler material have been appropriately blended, the guide chutes 272, 274 may direct the blended material towards the discharge conveyor 310. From here, the mixture formed from the blended material can be transported away from the machine 220. As shown, the conveyor 310 extends from the machine 220 to a side of the trailer 202. For instance, the discharge conveyor 310 may terminate at an ejection chute 312 that is located at a side edge of the trailer 202. The ejection chute 312 may have an opening formed in its bottom surface 314 directly adjacent to the discharge conveyor 310. Additionally, the ejection chute 312 may include a handle 316 that can be used to reposition the ejection chute 312 to a desired location. This enables the blended material to quickly and easily be removed from the trailer 202 by the discharge conveyor 310. For instance, a tote (not shown) can be located directly beneath the opening of the ejection chute 312, such that the blended material can drop directly therebeneath into the tote. The tote could be supported on a load cell to permit confirmation that all of the materials added to the bin 210 have been ground and deposited in the tote. Alternatively, the ejection chute 312 may have a drawer or other storage container (not shown) that can be removed and dumped into a receptacle.

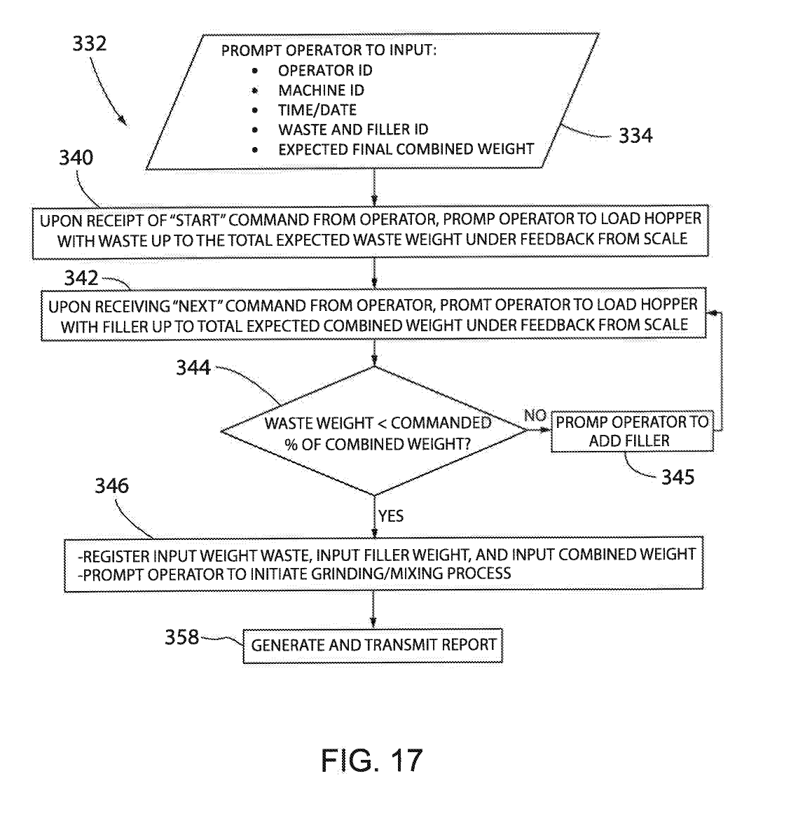

Referring now to FIG. 17, a flowchart 332 illustrating a series of steps to be performed in a method for managing waste and demonstrating compliance with applicable regulations is shown, according to an exemplary embodiment associated with the system 200 shown in FIGS. 13-16. Many of the same steps described above are similar, if not identical to those described above for the machine 20. These steps are designated by the same reference characters as the reference characters used for the steps associated with use of the machine 20 as described relative to FIG. 12, incremented by 200. This flowchart 332 can be thought of as viewing the process from the vantage point of the computer system (not shown). In step 334, the user inputs various identification information into the HMI (not shown), which are transmitted to the computer system and stored in its memory and/or uploaded. The computer system then confirms that the user has submitted a start command to the HMI, after which the computer monitors loading of the hopper 210 with waste up to the desired weight, such as about half of the total expected weight of the combined materials in this specific example in which the desired dilution level of waste material to filler material is less than half, as shown in step 340. The computer system will monitor the supply of waste material to the hopper 210 at this time. The computer system then confirms that the user has selected a next command on the HMI, and that the user has loaded the hopper 210 with the filler material up to the expected weight based on feedback through the HMI, as shown in step 342. (of course, the sequence could be reversed with filler material being supplied first and waste material being supplied second, so long as the dilution level in the combined mass of waste and filler materials meets the defined requirements). In step 344, the weight of waste material is compared to the total weight of the combined material. If the waste material is not sufficiently diluted, such as if the waste material accounts for more than half of the weight of the combined material, the computer system prompts the user to add additional filler material in step 345, and step 342 is repeated. Once the desired dilution level is reached, step 346 provides that the various readings from the load cells 256 are recorded, and computer system confirms that the user provides a command through the HMI to initiate the grinding and mixing process. The gate 212 is then opened, and the conveyors 214 and 216 transport the combined materials to the machine 220, where they are ground and mixed to form a mixture as described above, and the mixture is conveyed out of the machine 220 using the discharge conveyor 310. Finally, in step 358, a report is generated and transmitted. The blended material can then be disposed of as required under the relevant regulatory provisions.

It should be noted that this process could be tailored to achieve a specific dilution level or a level within a specified range of, for example, 51-55%. For example, if the user adds so much waste material to that the combined mass of the filler material and the waste material is over-diluted to, for example, 60%, the system could prompt the user to add additional filler material to bring the dilution level within the specified range.

While specific materials have not been discussed, it should be noted that the various components could be made of any suitable, durable materials, including but not limited to, plastic, stainless steel, other metals, and the like.

Other embodiments and uses of the invention will be apparent to those skilled in the art from consideration from the specification and practice of the invention disclosed herein. It is understood that the invention is not confined to the specific materials, methods, formulations, operating/assay conditions, etc., herein illustrated and described, but embraces such modified forms thereof as come within the scope of the following claims.

What is claimed is:

1. A system for processing waste comprising:
a machine comprising a blender that is configured to receive a quantity of waste material and a quantity of filler material and to grind the waste and filler materials and to mix them together to form a mixture;
a scale configured to weigh the quantity of waste material and the quantity of filler material; and
a computer system;
wherein the scale transmits measurement information to the computer system relative to the weight of waste material and the weight of filler material, and
wherein the computer system monitors dilution of the waste material to a desired level and generates a resultant report to ensure compliance with a regulation.

2. The system of claim 1, wherein the blender further comprises a rotating drum and a grinder in communication with an outlet of the drum.

3. The system of claim 2, further comprising a gate located beneath the grinder, the gate being selectively openable to discharge ground and materials into the receptacle.

4. The system of claim 2, further comprising a sizing screen located beneath the grinder, the sizing screen being selectively openable or of a fixed size to determine a final product size of ground and mixed materials.

5. The system of claim 2, wherein the computer system determines whether the waste material and the filler material are mixed to a designated dilution percentage.

6. The system of claim 5, wherein the dilution percentage of waste material results in the waste material being a minority based on mass relative to the mass of the mixture of the waste material and the filler material.

7. The system of claim 2, wherein the resultant report is encrypted and transmitted to a database that is accessible by a third-party computer.

8. The system of claim 1, further comprising:
a hopper configured to receive the quantity of waste material and the quantity of filler material; and
at least one conveyor extending from the hopper system to the machine.

9. The system of claim 8, wherein the scale monitors a weight of the hopper.

10. They system of claim 8, further comprising:
a hopper conveyor extending along the hopper;
a second conveyor extending from an exit of the hopper to an entrance of the machine;
a third conveyor extending from an exit of the machine to an ejection chute.

11. The system of claim 10, wherein the hopper system and the machine are mounted on a portable support.

12. A method of demonstrating compliance relating to dilution of a waste material comprising the steps of:
adding waste material and a filler material to a receptacle to form a combined mass;
mixing and grinding the combined mass in a blender to form a mixture;
weighing the combined mass, either before or after the mixing and grinding, generating a weight signal indicative thereof, and transmitting the signal to a computer;
using the computer, and relying at least in part on the signal, determining whether a quantity of waste material in the combined mass is diluted to a designated level; and
using the computer, at least one of storing and transmitting information regarding dilution of the waste material relative to the mixture.

13. The method of claim 12, wherein the weighing is performed before the mixing and grinding, and further comprising the steps of:
measuring the weight of the mixture after the mixing and grinding, generating a second signal indicative of the weight of the mixture, and transmitting the second signal to the computer; and
using the computer, comparing the first and second signals and determining whether the measured weight of the combined mass equals the measured weight of the mixture.

14. The method of claim 12, further comprising, using the computer, generating a transmission report summarizing the dilution of the waste material relative to the mixture and 1) storing the transmission report and/or 2) transmitting the transmission report to a third party computer.

15. The method of claim 12, further comprising, using the computer, determining whether the waste material in the combined mass is diluted to a designated level.

16. The method of claim 15, further comprising, using the computer, generating a compliance report when the computer determines that the waste material in the combined mass is diluted to a designated level.

17. The method of claim 15, further comprising, using the computer, generating an error signal and/or alert when the computer determines that the waste material in the combined mass is not diluted to a designated level.

18. The method of claim 12, further comprising, using the computer, the step of transmitting the measurement information to a database that is accessible by a compliance agency.

19. The method of claim 12, wherein the receptacle comprises a hopper, and further comprising:
transporting the combined mass from the hopper to the blender via a conveyor, and wherein weighing occurs prior to transporting.

20. The method of claim 12, wherein the receptacle comprises a bin located in the blender.
